(19) United States
(12) Patent Application Publication
(10) Pub. No.: US 2007/0202234 A1
(43) Pub. Date: Aug. 30, 2007

(54) Coffee flavour dispenser

(76) Inventor: Eddy Ludwig, Quebec (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/362,262

(22) Filed: Feb. 27, 2006

(51) Int. Cl. A23C 9/154

(52) U.S. Cl. 426/580

(57) ABSTRACT

The present invention relates to a flavour dispensing mechanism, for a coffee dispensing machine, and to a method of incorporating such mechanism into a coffee dispensing machine. The flavouring mechanism draws a metered amount of a flavouring liquid from one or more flavouring liquid source to a corresponding delivery tube by controllably actuating a flow regulating device, such as pump or valve, connected to the flavouring liquid source. A vent or a peristaltic pump is used to displace the flavouring liquid that may remain in the delivery tube following the delivery of the flavouring liquid to the coffee beverage and thus prevent unwanted dripping of flavouring liquid from the delivery tube post dispensing process.

### FIELD OF THE INVENTION

The present invention relates to flavour dispensers used in beverage-making equipment. More specifically, the invention relates to coffee flavour dispensers for dispensing a metered amount of flavouring liquid to a coffee beverage.

### BACKGROUND OF THE INVENTION

Flavoured beverages are increasingly popular with consumers. Beverage dispensing systems are commonly used to provide consumers with flavoured beverages such as chocolate, coffee, tea, and the like.

Numerous coffee dispensing systems provide flavoured coffee brewed from pre-flavoured coffee beans or grinds stored in the system. Pre-flavoured coffee beans are whole coffee beans that have been coated with flavouring during roasting. A metered amount of the pre-flavoured coffee beans stored in the dispensing system is ground and used to brew the flavoured coffee. Pre-flavoured coffee grinds are grinds of coffee to which flavouring has been added.

Many pre-flavoured coffees are produced using synthetic chemical flavourings. For many consumers, the use of synthetic chemical flavourings is a point against this type of coffee dispensing system. Of course, pre-flavoured coffee infused with natural flavourings may be used instead, offering rich aroma and better taste. Unfortunately, such naturally-flavoured coffee is often more expensive and may not be competitive in terms of cost.

As tastes differ around the world, there is a constant demand for consistency in quality. It can be quite difficult to obtain good pre-flavoured coffee grinds. The finer the grind, the more difficult it is to obtain good uniform mixing of the flavouring. Moreover, these systems that use pre-flavoured coffee have a high risk of contamination with other coffee products in the grinders and/or feeding equipment between coffee-making processes.

As disclosed in US Patent Application No. 2005/0066819, one possible solution to the problem of contamination is the use of in-cup vending systems in which stacked cups, each containing a portion of beverage-making ingredients, are stored in the dispenser of the vending machine. One obvious drawback to this system is the bulky size of the vending machine owing to the large volume of the stored stacked cups. Another solution to the contamination problem disclosed in US Patent Application No. 2005/0066819 is the use of stored beverage-making capsules. The drawback with this solution is the added bulk and cost of the packaging of the individual capsules.

U.S. Pat. No. 6,730,348 discloses dispensing a flavoured syrup in a manually positioned pre-packaged shake-mix-filled container for forming a flavoured slurried confection. This particular beverage dispensing system, designed for such beverages as milkshakes and not suited for such beverages as coffee, does not provide efficient means for preventing contamination from beverage ingredients between beverage-making processes.

### SUMMARY OF THE INVENTION

In accordance with one aspect of the present invention, there is provided a flavour dispensing mechanism for a coffee dispensing machine, for dispensing at least one flavouring liquid to a coffee beverage. The flavour dispensing mechanism includes at least one flavouring liquid source having an outlet for outputting a flow of a corresponding one of the at least one flavouring liquid. For each one of the at least one flavouring liquid source, the flavour dispensing mechanism includes drawing means for controllably drawing a metered amount of the corresponding flavouring liquid from the at least one flavouring liquid source, a delivery tube having an input end connected to the drawing means for receiving the metered amount of the corresponding flavouring liquid therefrom and an output end opposite the input end for delivering the metered amount of the corresponding flavouring liquid to the coffee beverage, and displacing means for displacing the metered amount of the corresponding flavouring liquid in the delivery tube, the displacing means being adapted to prevent dripping of the corresponding flavouring liquid from the output end of the delivery tube apart from delivering the metered amount thereof to the coffee beverage.

In an embodiment of the flavour dispensing mechanism, the drawing means preferably include a flow-regulating device, connected between the flavouring liquid source and the delivery tube, for drawing the flavouring liquid from the flavouring liquid source to the delivery tube, and a controller, connected to the flow-regulating device, for actuating the flow-regulating device to deliver the metered amount of the flavouring liquid to the delivery tube. According to one embodiment, the flow-regulating device may preferably include a pump. According to another embodiment, the flow-regulating device may preferably include a valve.

In accordance with another embodiment of the present invention, there is provided a coffee dispensing machine with a flavour dispensing mechanism for dispensing at least one flavouring liquid to a coffee beverage. The flavour dispensing mechanism includes at least one flavouring liquid source having an outlet for outputting a flow of a corresponding one of the at least one flavouring liquid. For each one of the at least one flavouring liquid source, the flavour dispensing mechanism includes drawing means for controllably drawing a metered amount of the corresponding flavouring liquid from the at least one flavouring liquid source, a delivery tube having an input end connected to the drawing means for receiving the metered amount of the corresponding flavouring liquid therefrom and an output end opposite the input end for delivering the metered amount of the corresponding flavouring liquid to the coffee beverage, and displacing means for displacing the metered amount of the corresponding flavouring liquid in the delivery tube, the displacing means being adapted to prevent dripping of the corresponding flavouring liquid from the output end of the delivery tube apart from delivering the metered amount thereof to the coffee beverage.

In an embodiment of the present invention, the coffee dispensing machine may include selection means for selecting the at least one flavouring liquid, the selection means being in communication with the drawing means.

In accordance with another aspect of the invention, there is provided a method for incorporating, to a coffee dispensing machine, a flavour dispensing mechanism for dispensing at least one flavouring liquid to a coffee beverage. The method includes the steps of:
providing at least one flavouring liquid source having an outlet for outputting a flow of a corresponding one of the at least one flavouring liquid;
providing drawing means for controllably drawing a metered amount of the flavouring liquid from the source of flavouring liquid;
connecting an input end of a delivery tube to the drawing means for receiving the metered amount of the corresponding flavouring liquid therefrom, and providing an output end opposite the input end of the delivery tube for delivering the metered amount of flavouring liquid to a coffee beverage; and
providing displacing means for displacing the metered amount of the corresponding flavouring liquid in the delivery tube, the displacing means being adapted to prevent dripping of the corresponding flavouring liquid from the output end of the delivery tube apart from delivering the metered amount thereof to the coffee beverage.

Preferably, the above method includes the step of providing selection means for selecting the at least one flavouring liquid, the selection means being in communication with the drawing means.

Advantages of the present invention include a flavour dispensing mechanism for a coffee dispensing machine that offers an efficient, consistent, cost-effective means of producing a quality flavoured coffee.

The objects, advantages and other features of the present invention will become more apparent and be better understood upon reading of the following non-restrictive description of the preferred embodiments of the invention, given with reference to the accompanying drawings. The accompanying drawings are given purely for illustrative purposes and should not in any way be interpreted as limiting the scope of the invention.

### BRIEF DESCRIPTION OF THE DRAWINGS

FIG. 1 is a perspective view of a coffee dispensing machine according to a preferred embodiment of the invention.

FIG. 2 is a perspective view of the interior of a coffee dispensing machine showing a flavour dispensing mechanism incorporated into the door of the coffee dispensing machine, according to a preferred embodiment of the invention.

FIG. 3 is a front view of a flavour dispensing mechanism incorporated into the door of the coffee dispensing machine, according to a preferred embodiment of the invention.

FIG. 4 is a front view of a flavour dispensing mechanism incorporated into the door of the coffee dispensing machine, according to another preferred embodiment of the invention.

FIG. 5 is a front view of a flavour dispensing mechanism incorporated into the door of the coffee dispensing machine, according to yet another preferred embodiment of the invention.

### DESCRIPTION OF PREFERRED EMBODIMENTS OF THE INVENTION

The present invention will be described more fully hereinafter with reference to the accompanying drawings, in which like numerals refer to like elements throughout.

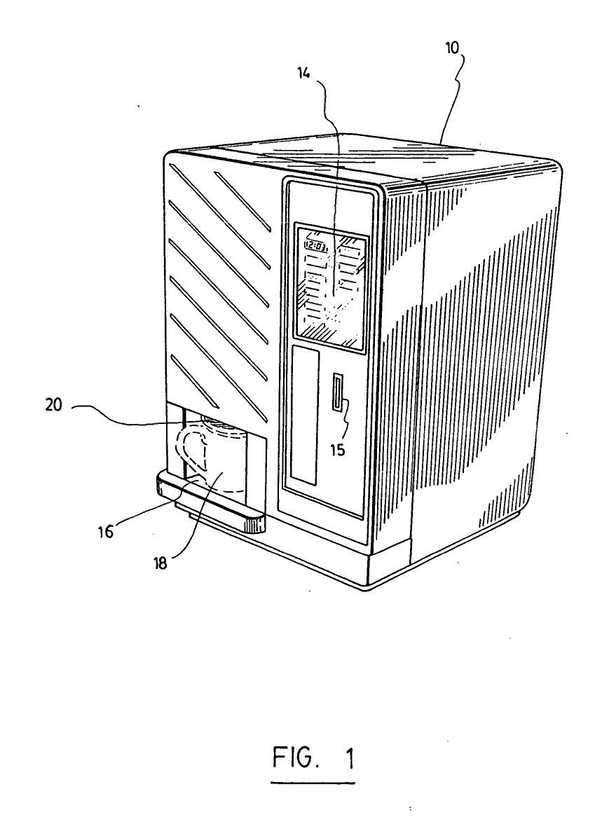

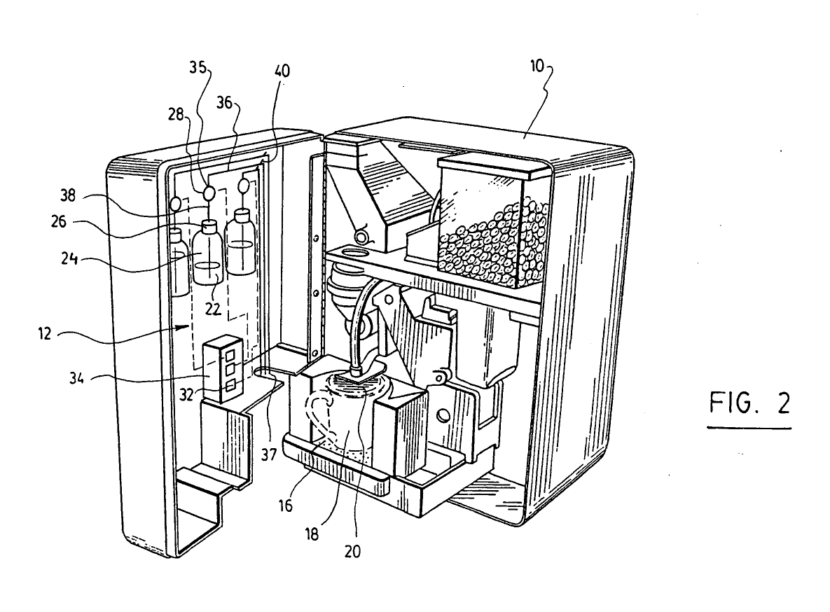

Referring to FIGS. 1, and 2, the present invention provides a flavour dispensing mechanism (12) for a coffee dispensing machine (10), for dispensing at least one flavouring liquid (22) to a coffee beverage (20). A coffee dispensing machine (10) having such a flavour dispensing mechanism (12) is also provided. The flavour dispensing mechanism (12) may be integrated into the coffee dispensing machine (10) upon its manufacture or could be incorporated into and adapted to an existing coffee dispensing machine.

Given the variety of coffee dispensing machines in existence, the coffee dispensing machine (10) may be embodied by any suitable one of these numerous varieties. The coffee dispensing machine (10) may be a counter-top or a free-standing floor model for domestic and/or commercial use. It may be a vending machine, incorporating a payment system (15), or it could provide beverages free of charge. It preferably includes a dispensing area (16) for dispensing the coffee beverage (20) Into a receiving cup (18). The coffee dispensing machine (10) may dispense additional beverages, other than coffee, such as hot chocolate, tea, infusions or simply hot water. Furthermore, the coffee dispensing machine (10) may allow the consumer to selectively add, in addition to a flavouring liquid, any other appropriate additive to the coffee beverage (20) such as, for example, milk, cream, sugar, or the like.

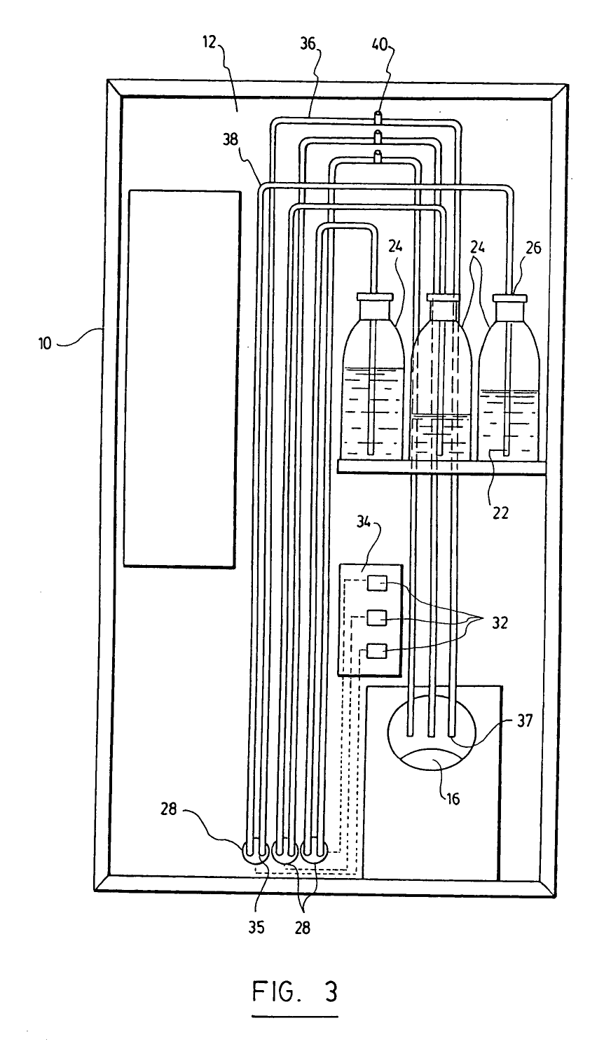

Referring to FIG. 3, the flavour dispensing mechanism according to one embodiment of the present invention will now be described in more detail. The flavour dispensing mechanism (12) includes at least one flavouring liquid source (24). Of course, any person versed in the art will appreciate that the flavour dispensing mechanism (12) may include a number of flavouring liquid sources (24). Although three flavouring liquid sources (24) are depicted in the accompanying drawings, it is understood that the number of sources shown is purely for illustrative purposes and should not be construed as limitative in any way. Any suitable container, for example a plastic bottle, which can effectively hold a volume of flavouring liquid (22) may serve as a flavouring liquid source. The source (24), or bottle, has an outlet (26) for allowing the outflow of the flavouring liquid (22). The outlet may be embodied by something as simple as the opening in the neck of a bottle.

As for the flavouring liquid (22), it may be embodied by any appropriate substance that may be added to a coffee beverage. It may be synthetic, i.e. artificial, or natural. It may be an aromatic liquid essence or syrup, and may for example include vanilla extract, chocolate syrup, strawberry cream, rum, etc.

The coffee beverage itself is preferably a neutral, unflavoured base, brewed from either fine or coarse grinds to which is dispensed a flavouring liquid (22). By using a neutral, unflavoured base, the cost of production is kept low while optimising the quality of the coffee beverage by minimising the risk of contamination during the coffee-making process.

For each flavouring liquid source (24), the flavour dispensing mechanism (12) includes drawing means for controllably drawing a metered amount of the corresponding flavouring liquid (22) from the source (24). The drawing means preferably include a flow-regulating device, embodied in FIG. 3 by a pump (28) connected between the flavouring liquid source (24) and the input end (35) of a delivery tube (36) which has an output end (37) positioned to deliver the flavouring liquid to the coffee beverage. The pump (28) therefore draws the flavouring liquid (22) from the flavouring liquid source (24) to the delivery tube (36). A controller (32), connected to the pump (28), is also provided for actuating the pump (28) to deliver the metered amount of the flavouring liquid (22) to the delivery tube (36). It will be understood by one skilled in the art that the controller may be embodied by any combination of mechanical and/or electronic components able to operate the pump (28) to open and close on command. In the illustrated embodiments, the controller of each pump is embodied by appropriate circuit components on a single printed circuit board. Alternatively, separate circuits could embody each controller. The controller may incorporate a power supply for the corresponding pump, or separate power supplies may be provided. The controllers (32) may be programmed either by the manufacturer or the operator to actuate the drawing of a pre-determined metered amount of flavouring liquid (22) from the corresponding flavouring liquid source (24).

The flavour dispensing mechanism may further include, for each one of the flavouring liquid sources (24), a supply tube (38) connected between the outlet (26) of the flavouring liquid source (24) and the pump (28). The supply tube (38) is preferably made of silicone, for ease of installation (silicone tubing is generally easily manipulated) and reduction of cost. In some applications it could also be made of plastic or any other appropriate material.

In addition, the flavour dispensing mechanism (12) may include a master controller (34), to which is connected the controller associated with each flow-regulating device, for directing each controller. It may also supply the necessary power to operate the drawing means, as in the case of a pump.

For each flavouring liquid source (24), displacing means (embodied by a vent (40) in FIG. 3) is also provided in the corresponding delivery tube (36) for displacing the metered amount of the flavouring liquid in this delivery tube (36), and are adapted to prevent dripping of flavouring liquid (22) from the output end (37) of the delivery tube (36), apart from delivering the metered amount to the coffee beverage (20).

To prevent the contamination of successive coffee beverages (20) and thus assure the taste quality of the coffee beverage, extraneous unwanted drips of flavouring liquid between coffee-making processes should be prevented. Of course, preventing unwanted drips has the added benefit of preventing the mess caused by such drips. This may be accomplished via the provision of a vent (40) in the delivery tube (36), and the proper positioning of these components. The vent (40) and delivery tube (36) must be positioned such as to allow the metered flavouring liquid (22) that has accumulated in the portion of the delivery tube (36) immediately descending into the dispensing area (16) to be displaced along the delivery tube (36), out of the output end (37) of the delivery tube and into the coffee beverage (20) located in the dispensing area (16). The vent (40) may be embodied by a tube inserted into an opening provided in the delivery tube (36). Preferably, it may be a plastic T-connector tube spliced into the delivery tube (36) at a point near where the delivery tube starts to descend toward the dispensing area (16). Alternatively, the vent may be incorporated into the flow-regulating device. For example, a valve with an integrated vent may be used. One other option to displace the flavouring liquid in the delivery tube is to use a peristaltic pump. A peristaltic pump applies a negative pressure to the delivery tube to displace the flavouring liquid therein and thereby prevents any unwanted dripping.

In the embodiment illustrated in FIG. 3, a small pump, such as a micro-pump, is preferably used as drawing means, to minimise cost and the space taken by the pump (28). However, the drawback of a micro-pump is its limited pumping power. As such, to maximise its efficiency, the micro-pump (28) may be placed below the flavouring liquid source (22), as shown in FIG. 3, to benefit from the added force of gravity acting on the flavouring liquid (22) in the supply tube (38). As a pump (28) of this type usually remains open, it is possible, under some circumstances, that liquid from the flavouring liquid source be drawn out between activations of the pump with sufficient pressure to allow it to be pushed along the delivery tube (36) and drip out of its output end (37). To prevent such unwanted dripping of flavouring liquid (22) from the delivery tube (36) apart from delivering the selected flavouring liquid to the coffee beverage (20), the delivery tube of this embodiment preferably runs up from the pump (28) to a point above the flavouring liquid source (24) and then turns to run down as directly as possible towards the dispensing area (16). The vent (40) is spliced into the delivery tube (36) at a point just before the delivery tube turns to descend towards the dispensing area (16). In this way, any flavouring liquid that accumulates in the portion of the delivery tube before the turn remains in the delivery tube, the residual pumping pressure on the liquid being insufficient to propel the liquid past the turn in the delivery tube, and flavouring liquid in the descending portion of the delivery tube after the turn is displaced along the delivery tube (36), out of the output end (37) of the delivery tube and into the coffee beverage (20) located in the dispensing area (16) through the use of the vent (40). If a peristaltic pump is used instead of a micro-pump, there is no need for vent (40) in the delivery tube (36)—the peristaltic pump itself preventing any unwanted dripping. Moreover, the delivery tube (36) need not run up from the pump (28) to a point above the flavouring liquid source (24) in this embodiment.

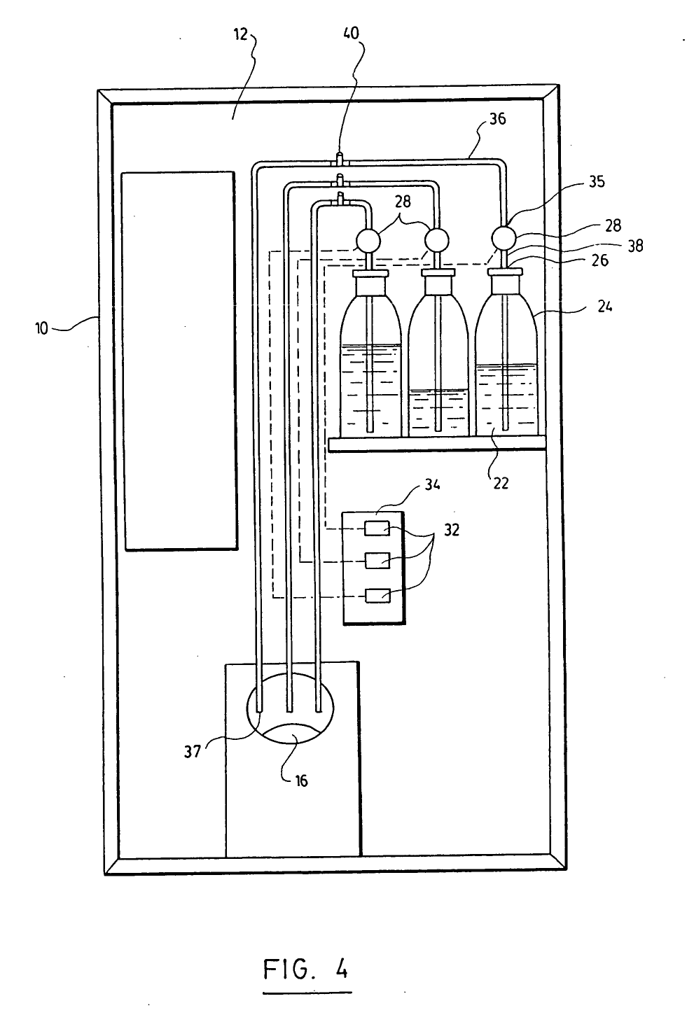

In the embodiment illustrated in FIG. 4, a sufficiently strong and efficient pump (28) is used to draw the flavouring liquid (22) from the flavouring liquid source (24). One drawback of such a pump is its relatively elevated cost and bulky volume, but it could still be considered for particular applications of the present invention. The strong pump (28) may be positioned above the flavouring liquid source (22), as shown in FIG. 4. In this case, to prevent unwanted dripping of flavouring liquid (22) from the delivery tube (36, the delivery tube (36) runs from the pump down to the dispensing area (16) and the vent (40) is spliced into the delivery tube (36) at a point just before the delivery tube turns to descend towards the dispensing area (16). Consequently, flavouring liquid that accumulates in the portion of the delivery tube before the turn remains in the delivery tube, and flavouring liquid present in the descending portion of the delivery tube after the turn is displaced along the delivery tube (36), out of the output end (37) of the delivery tube and into the coffee beverage (20) located in the dispensing area (16) through the use of the vent (40). Again, in the case of a peristaltic pump, there is no vent (40) in the delivery tube (36)—the peristaltic pump itself preventing any unwanted dripping.

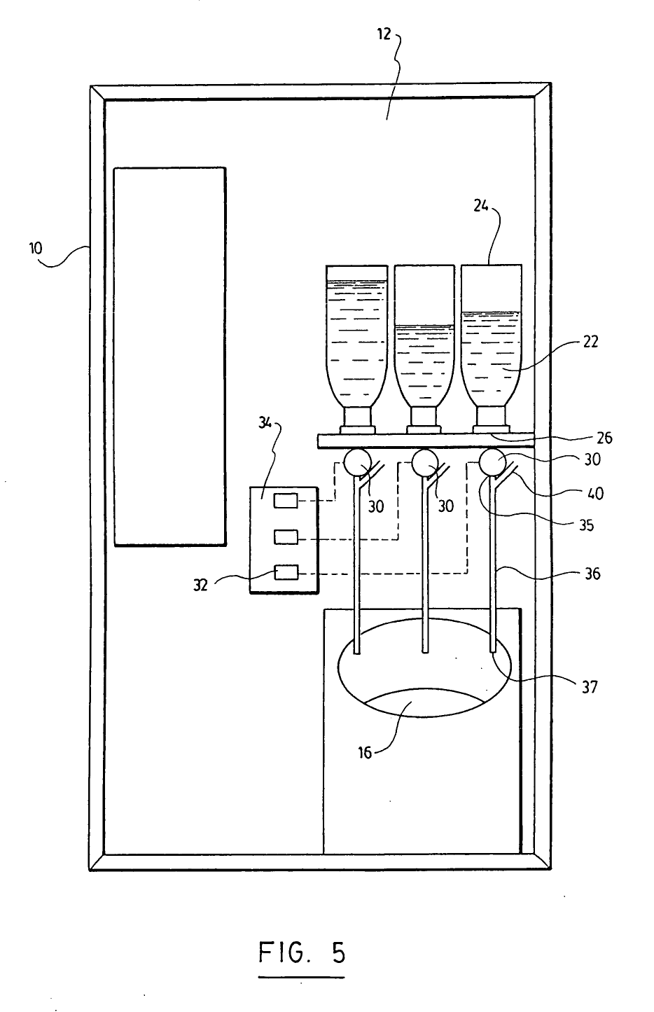

In the embodiment illustrated in FIG. 5, a valve (30) tapped into the flavouring liquid source (24) is actuated by the controller (32) to draw a metered amount of flavouring liquid (22) from the flavouring liquid source (24) into the delivery tube (36) connected to the valve (30). Unwanted dripping is prevented by providing a vent (40) at the junction of the valve (30) with the delivery tube (36). Once again, the vent (40) causes the flavouring liquid (22) that may otherwise remain in the delivery tube (36) following the dispensing of the flavouring liquid into the coffee beverage (20) and drip out at a later time, to be displaced out of the delivery tube into the coffee beverage during the actual dispensing process.

By including a separate delivery tube (36) for each flavouring liquid (22), the contamination that would result from using the same tube is circumvented. Like the supply tube (38), the delivery tube (36) may be made of silicone or plastic to facilitate installation and reduce cost. The output end (37) of the delivery tube (36), which delivers the flavouring liquid (22) to the coffee beverage (20), may be provided with a nozzle preferably made of stainless steel or rigid plastic. The nozzle may serve to better direct and control the flow of flavouring liquid (22) to the coffee beverage (20). The nozzle may also advantageously be removable to allow for cleaning the existing nozzle or replacing the existing nozzle with a new one.

Referring back to FIGS. 1 and 2, the coffee dispensing machine (10) of the present invention may include selection means by which the consumer may select a flavouring liquid (22). The selection means may, for example, be simple buttons, a conventional display screen in association with a keypad or a tactile display screen (14) that incorporates an electronic keypad into the display screen. The buttons may be associated with a particular flavouring liquid and even be used for portion control. The length of time the user presses a button determining the metered amount of flavouring liquid provided. The display screen may display queries regarding the choice of flavouring liquid. Advantageously, it may be of a size to display the entire selection menu at a glance. Typically, the keypad transmits the choice information directly to controllers (32) or indirectly via master controller (34).

For example, a consumer wanting a flavoured coffee beverage consults the selection menu presented on the display screen (14) and presses the key associated with his choice of flavouring liquid (22). The pressed key sends an electronic signal to the controller (22) associated with the selected flavouring liquid (22). The controller (22) in turn actuates the pump (28) or valve (30), turning the pump or valve on and then off. While the pump (28) or valve (30) is on, flavouring liquid (22) is drawn from the flavouring liquid source (24) passing through the delivery tube (36) and into the receiving cup (18). By actuating the pump or valve on and off, a pre-determined metered amount of the flavouring liquid is delivered to the receiving cup. Any unwanted extraneous drips are prevented by venting the delivery tube (36) via the appropriate positioning of the vent (40) provided.

In accordance with another aspect of the present invention, there is generally provided a method for incorporating a flavour dispensing mechanism into a coffee dispensing machine which includes the steps of:
a. providing at least one flavouring liquid source having an outlet for outputting a flow of the flavouring liquid.

This may be accomplished by providing containers holding a volume of the flavouring liquid and attaching these containers or affixing some supporting mechanism such as a shelf on which to rest these containers onto the inside of a wall or door of the coffee dispensing machine. The containers may be positioned such that the outlet is facing the top of the machine or the bottom, dependent on the drawing means to be used.
b. providing drawing means for controllably drawing a metered amount of the flavouring liquid from the source of flavouring liquid.

For drawing a metered amount of flavouring liquid, a flow-regulating device, such as a pump or valve, may be connected to a flavouring liquid source, preferably via a supply tube, and to a controller that actuates the flow-regulating device to draw the metered flow of flavouring liquid. In the case where the flow-regulating device used is a pump, the pump may be placed in a location that optimises its operation. A weak pump connected to a flavouring liquid source via a supply tube may be placed below the flavouring liquid source so as to benefit from the force of gravity acting on the flavouring liquid flowing out of the source into the supply tube, and thus, increase its drawing efficiency. A strong pump may be placed above or below the flavouring liquid source, whichever location best suits the incorporation method. In the case where the flow-regulating device is a valve, the valve may be tapped into the bottoming-facing outlet of the flavouring liquid source.
c. connecting an input end of a delivery tube to the drawing means for receiving the metered amount of the corresponding flavouring liquid, and providing an output end opposite the input end of the delivery tube for delivering the metered amount of flavouring liquid to a coffee beverage.

The input end of the delivery tube may be connected to a pump or valve by conventional connectors. The delivery tube may be then affixed to the wall or door of the coffee machine using appropriate holders such as clamps.
d. providing displacing means for displacing the metered amount of the flavouring liquid in the delivery tube, the displacing means adapted to prevent dripping of the flavouring liquid from the output end of the delivery tube apart from delivering the metered amount of flavouring liquid to the coffee beverage.

This may be accomplished by using a vent as the displacing means, that is, by inserting a small tube into an opening provided in the delivery tube. Preferably, it may be a plastic T-connector tube spliced into the delivery tube. The vent should be located in such a position as to allow the metered flavouring liquid that has accumulated in the portion of the delivery tube immediately descending into the dispensing area to be displaced along the delivery tube, out of the output end of the delivery tube and into the coffee beverage located in the dispensing area. Preferably, the vent is positioned at the location of the highest point of the delivery tube, just before the highest turning point of the delivery tube—near where the delivery tube starts to descend toward the dispensing area. Alternatively, a valve with the vent located at the junction of the valve with the delivery tube or valve with an integrated vent may be used. Another option would be to use a peristaltic pump which encompasses the displacing means, and in this way forego the use of a vent altogether.

The method above may further include the step of:
e. providing selection means for selecting a flavouring liquid, the selection means being in communication with the drawing means.

This may be accomplished by providing buttons associated with a particular flavouring liquid. The selection signal is transmitted to the pump or valve and used for portion control. Alternatively, a conventional display screen in association with a keypad or a tactile display screen connected to the controller directly, or indirectly via the master controller, may be used. The selection signal transmitted from the keypad is transmitted to the controller which then actuates the pump or valve.

The method above may be implemented by adapting the flavour dispensing machine within a door of the coffee machine. This may be accomplished by simply affixing the components of the flavour dispensing mechanism to the inside of the door of the coffee dispensing machine, for example by using clamps or clips.

Numerous modifications could be made to any of the embodiments described above without departing from the scope of the present invention as defined in the appended claims.

1. A flavour dispensing mechanism for a coffee dispensing machine, for dispensing at least one flavouring liquid to a coffee beverage, comprising:
at least one flavouring liquid source having an outlet for outputting a flow of a corresponding one of said at least one flavouring liquid; and
for each one of said at least one flavouring liquid source:
drawing means for controllably drawing a metered amount of the corresponding flavouring liquid from the at least one flavouring liquid source;
a delivery tube having an input end connected to said drawing means for receiving the metered amount of the corresponding flavouring liquid therefrom and an output end opposite said input end for delivering said metered amount of the corresponding flavouring liquid to the coffee beverage; and
displacing means for displacing the metered amount of the corresponding flavouring liquid in said delivery tube, said displacing means being adapted to prevent dripping of the corresponding flavouring liquid from the output end of the delivery tube apart from said delivering the metered amount thereof to the coffee beverage.

2. A flavour dispensing mechanism according to claim 1, wherein said at least one flavouring liquid source comprises at least one container holding a volume of one of said at least one flavouring liquid.

3. A flavour dispensing mechanism according to claim 1, wherein said at least one flavouring liquid source comprises a plurality of containers, each of said plurality of containers holding a volume of one of said at least one flavouring liquid.

4. A flavour dispensing mechanism according to claim 1, wherein said drawing means for each one of said at least one flavouring liquid source comprise:
a flow-regulating device, connected between the flavouring liquid source and the delivery tube, for drawing the flavouring liquid from the flavouring liquid source to the delivery tube; and
a controller, connected to the flow-regulating device, for actuating the flow-regulating device to deliver said metered amount of the flavouring liquid to the delivery tube.

5. A flavour dispensing mechanism according to claim 4, wherein said flow-regulating device comprises a pump.

6. A flavour dispensing mechanism according to claim 5, wherein, for each of said flavouring liquid source, the corresponding pump is positioned below said flavouring liquid source.

7. A flavour dispensing mechanism according to claim 6, wherein, for each of said flavouring liquid source, the corresponding displacing means comprise a vent positioned above said flavouring liquid source.

8. A flavour dispensing mechanism according to claim 6, wherein the pump is a peristaltic pump, said displacing means comprising a negative pressure applied to said delivery tube by said peristaltic pump.

9. A flavour dispensing mechanism according to claim 5, wherein, for each of said flavouring liquid source, the corresponding pump is positioned above said flavouring liquid source.

10. A flavour dispensing mechanism according to claim 9, wherein, for each of said flavouring liquid source, the corresponding displacing means comprise a vent positioned above said flavouring liquid source.

11. A flavour dispensing mechanism according to claim 9, wherein the pump is a peristaltic pump, said displacing means comprising a negative pressure applied to said delivery tube by said peristaltic pump.

12. A flavour dispensing mechanism according to claim 4, wherein said flow-regulating device comprises a valve.

13. A flavour dispensing mechanism according to claim 12, wherein, for each of said flavouring liquid source, the displacing means comprise a vent integral to said valve.

14. A flavour dispensing mechanism according to claim 12, wherein, for each of said flavouring liquid source, the corresponding displacing means comprise a vent positioned immediately below the corresponding valve.

15. A flavour dispensing mechanism according to claim 4, wherein said flavour dispensing mechanism further comprises a printed circuit board incorporating the controller of the drawing means for each of said at least one flavouring liquid source.

16. A flavour dispensing mechanism according to claim 1, wherein said flavour dispensing mechanism further comprises a supply tube connected between the outlet of the at least one flavouring liquid source and the drawing means for each one of said at least one flavouring liquid source.

17. A flavour dispensing mechanism according to claim 16, wherein said supply tube is made of plastic or silicone.

18. A flavour dispensing mechanism according to claim 1, wherein said delivery tube is made of plastic or silicone.

19. A flavour dispensing mechanism according to claim 1, wherein said delivery tube is provided with a nozzle at the output end thereof.

20. A flavour dispensing mechanism according to claim 19, wherein said nozzle is stainless steel or rigid plastic.

21. A coffee dispensing machine with a flavour dispensing mechanism for dispensing at least one flavouring liquid to a coffee beverage, said flavour dispensing mechanism comprising:
at least one flavouring liquid source having an outlet for outputting a flow of a corresponding one of said at least one flavouring liquid; and
for each one of said at least one flavouring liquid source:
drawing means for controllably drawing a metered amount of the corresponding flavouring liquid from the at least one flavouring liquid source;
a delivery tube having an input end connected to said drawing means for receiving the metered amount of the corresponding flavouring liquid therefrom and an output end opposite said input end for delivering said metered amount of the corresponding flavouring liquid to the coffee beverage; and
displacing means for displacing the metered amount of the corresponding flavouring liquid in said delivery tube, said displacing means being adapted to prevent dripping of the corresponding flavouring liquid from the output end of the delivery tube apart from said delivering the metered amount thereof to the coffee beverage.

22. A coffee dispensing machine according to claim 21, wherein said coffee dispensing machine comprises selection means for selecting said at least one flavouring liquid, said selection means being in communication with said drawing means.

23. A coffee dispensing machine according to claim 22, wherein said selection means comprise buttons for effecting a choice of said at least one flavouring liquid.

24. A method for incorporating, into a coffee dispensing machine, a flavour dispensing mechanism for dispensing at least one flavouring liquid to a coffee beverage, comprising the steps of:
providing at least one flavouring liquid source having an outlet for outputting a flow of a corresponding one of said at least one flavouring liquid;
providing drawing means for controllably drawing a metered amount of said flavouring liquid from said source of flavouring liquid;
connecting an input end of a delivery tube to said drawing means for receiving the metered amount of the corresponding flavouring liquid therefrom, and providing an output end opposite said input end of said delivery tube for delivering the metered amount of flavouring liquid to a coffee beverage; and
providing displacing means for displacing the metered amount of the corresponding flavouring liquid in said delivery tube, said displacing means being adapted to prevent dripping of the corresponding flavouring liquid from the output end of the delivery tube apart from said delivering the metered amount thereof to the coffee beverage.

25. A method for incorporating, into a coffee dispensing machine, a flavour dispensing mechanism according to claim 24, further comprising the step of providing selection means for selecting said at least one flavouring liquid, said selection means being in communication with said drawing means.

26. A method for incorporating, into a coffee dispensing machine, a flavour dispensing mechanism according to claim 24, further comprising the step of incorporating the flavour dispensing machine within a door of the coffee machine.
